(19) United States
(12) Patent Application Publication
(10) Pub. No.: US 2007/0235020 A1
(43) Pub. Date: Oct. 11, 2007

(54) MULTI-ZONE GAS FIREPLACE SYSTEM AND METHOD FOR CONTROL

(76) Inventors: Douglas Ernest Hills, Cloverdale (CA); Tak Ming Peter Yuen, Surrey (CA)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/682,980

(22) Filed: Mar. 7, 2007

Related U.S. Application Data
(60) Provisional application No. 60/743,420, filed on Mar. 7, 2006.
(60) Provisional application No. 60/743,413, filed on Mar. 7, 2006.

(51) Int. Cl. F23Q 2/32; A21C 13/00; F24B 1/18

(52) U.S. Cl. 126/512; 431/125; 126/281

(57) ABSTRACT

A multi-zone gas fireplace system and method for control are provided. An exemplary embodiment of the multi-zone gas fireplace system comprises a firebox, a multi-zone burner system, and a control system. The multi-zone burner system comprises a plurality of burners located in a plurality of zones, a plurality of control valves coupled to the plurality of burners, a gas supply which supplies a gas to the burners, and an ignition source configured to ignite the gas. The control system comprises an input element responsive to a user input, a processor in communication with the input element, and an output element in communication with the processor, such that the control system is operative to automatically provide a variable flame display in conjunction with the multi-zone burner system.

### CROSS-REFERENCE TO RELATED APPLICATIONS

This Application claims priority to and the benefit of U.S. Provisional Patent application Ser. No. 60/743,420 filed on Mar. 7, 2006 and entitled “MULTI-ZONE GAS FIREPLACE BURNER AND CONTROL SYSTEM AND METHOD.” This Application also claims priority to and the benefit of U.S. Provisional Patent Application No. 60/743,413 filed on Mar. 7, 2006, and entitled “REMOTE CONTROLLED GAS FIREPLACE SYSTEM.” Both applications are herein incorporated in their entirety by reference.

### FIELD OF INVENTION

The present invention relates to a gas fireplace. More particularly, the present invention relates to a multi-zone gas fireplace system and method for control.

### BACKGROUND OF THE INVENTION

Gas fireplace systems have long been used by individuals to enjoy the benefits of a fireplace experience, but without the disadvantages associated with operating a wood-burning fireplace. For instance, lighting a wood-burning fireplace is generally more difficult and time consuming than lighting a gas fireplace, which typically may be ignited by a simple spark or pilot flame. Another advantage of gas fireplaces is that the flame in the fireplace may be controlled by adjusting a gas control valve. Controlling the flame in a wood-burning fireplace, on the other hand, requires careful attention to wood placement, the amount of wood, the type of wood etc. Furthermore, wood-burning fireplaces produce undesirable soot and other byproducts of burnt wood. Gas fireplaces, on the other hand, are cleaner, and require minimal clean-Lip after operation.

Gas fireplaces, however, have some disadvantages over wood-burning fireplaces.

Wood-burning fireplaces are aesthetically pleasing in that the flames in the fireplace, for example, “jump” from place to place, vary in intensity and color, highlight the dark burning wood, and/or provide glowing wood embers. Some gas fireplaces attempt to reproduce this aesthetic appeal by using faux log systems, Such as ceramic logs which cover and substantially hide the gas burner, and which do not decompose when exposed to the beat of the burning gas.

However, merely using ceramic logs does not adequately reproduce the wood-burning fireplace experience. The sights, smell, sound, varying intensity, varying location of the flames, and the general color and overall appearance of the wood-burning fireplace have been difficult to replicate in a gas fireplace. Existing gas fireplaces are not capable of selectively burning gas in different zones within the fireplace, let alone automatically varying the locations and/or intensity of the flames for such zones during operation.

Furthermore, current gas fireplace systems generally have a switch or valve located somewhere near the fireplace which allows for the gas supply to be turned on and/or for the gas to be ignited. After the switch is turned on, the user has no more control over the fireplace with the exception of adjusting overall intensity of the flames or turning the flames completely off.

### SUMMARY OF THE INVENTION

In accordance with various aspects of the present invention, a multi-zone gas fireplace system and method for control are provided. In accordance with an exemplary embodiment, the multi-zone gas fireplace system comprises a firebox, a multi-zone burner system, and a control system.

According to an exemplary embodiment of the present invention, the multi-zone burner system is configured within the firebox, and it comprises a plurality of burners, that are located in a plurality of zones within the firebox. The multi-zone burner system further comprises a gas supply that provides a gas to the burners through a plurality of control valves. The control valves are coupled to the gas burners and the control valves regulate a plurality of flow rates of the gas in order to provide a variable flame display. The multi-zone burner system also comprises an ignition source configured to ignite the gas to produce the variable flame display.

According to an exemplary embodiment of the present invention, the control system is in communication with the multi-zone burner system and comprises an input element that is responsive to a user input, a processor in communication with the input element, and an output element in communication with the processor. The control system communicates with the valves in the multi-zone burner system in order to adjust the flow rates of the valves in order to provide the variable flame display.

In other exemplary embodiments of the invention, the control system has multiple configurations, adjustable parameters and/or settings which allow a user to adjust the intensity, location, color, size, heat, and other characteristics of the flame within the gas fireplace by communicating with the plurality of control valves and/or other components within the gas fireplace. Through the control system, a user may adjust the flames to provide a realistic simulation of a wood-burning fireplace, for example, by providing a larger, more intense flame produced by one of the gas burners in one zone location, while at the same time a flame of a different intensity and size is produced by another gas burner in a different zone location. In various embodiments, the user interacts with the multi-zone fireplace system by programming and/or choosing a program from the control system. Once a program is chosen, the control system automatically makes adjustments to the multi-zone fireplace system in accordance with the program.

In another embodiment of the invention, the control system may be configured to simulate the cycle of a wood-burning fireplace. For example, the control system may be configured to have a flame start off small in one location or zone of the fireplace, for example, with only one gas burner being utilized. The control system may be configured to have the flame associated with one or more gas burners grow over time, and/or initiate other burners to start producing flames. Moreover, the control system may be further configured to have the flame intensity of one or more burners slowly decrease over time, so as to simulate a dying-out wood fire. In various embodiments, the control system can comprise pre-programmed settings for the various flame characteristics depending on the type of fire the user desires to simulate, or can provide for manual selections of such characteristics.

In accordance with an exemplary embodiment of the present invention, the control system comprises a wireless transceiver and a remote control, with the wireless transceiver located proximate the gas fireplace. The wireless transceiver receives command signals from the remote control module and communicates with the control valves and other components of the multi-zone burner system in order to simulate the variably-controlled flame. The fireplace transceiver can be configured to transmit data, such as temperature, flame status, flame location, and/or other parameters, back to the remote control module so the user may view the data. In other embodiments of the invention, a control panel may be located proximate the fireplace such that the control panel communicates directly with the control valves and other components of the fireplace, in addition to or instead of the wireless transceiver and remote control module.

### BRIEF DESCRIPTION OF THE DRAWING FIGURES

The subject matter of the invention is particularly pointed out and distinctly claimed in the concluding portion of the specification. The invention, however, both as to structure and method of operation, may best be understood by reference to the following description taken in conjunction with the claims and the accompanying drawing figures, in which like parts may be referred to by like numerals:

FIG. 1 illustrates a block diagram of an exemplary embodiment of a multi-zone gas fireplace system;

FIG. 2A illustrates a block diagram of an exemplary multi-zone burner system and control system in accordance with another exemplary embodiment of the present invention;

FIG. 2B illustrates a block diagram of an exemplary multi-zone burner system and control system in accordance with another exemplary embodiment of the present invention;

FIG. 3A illustrates a front view of a multi-zone gas fireplace system according to an exemplary embodiment of the present invention;

FIG. 3B illustrates a front view of a multi-zone gas fireplace system according to another exemplary embodiment of the present invention;

FIG. 3C illustrates a perspective view of a multi-zone gas fireplace system according to another exemplary embodiment of the present invention;

FIG. 3D illustrates a composite front view and hidden view of a multi-zone gas fireplace system according to another exemplary embodiment of the present invention;

FIG. 4 illustrates a block diagram of an exemplary embodiment of the invention, showing components of a control system for use in conjunction with a multi-zone burner system;

FIG. 5 illustrates a control system operating in conjunction with a multi-zone gas fireplace system according to an exemplary embodiment of the invention;

FIG. 6 illustrates a control system operating in conjunction with a multi-zone gas fireplace system according to a further embodiment of the present invention;

FIG. 7 illustrates a control system according to an exemplary embodiment of the present invention.

### DETAILED DESCRIPTION

The description that follows is not intended to limit the scope, applicability, or configuration of the invention in any way; rather, it is intended to provide a convenient illustration for implementing various embodiments of the invention. As will become apparent, various changes may be made in the function and arrangement of the elements described in these embodiments without departing from the scope of the invention. It should be appreciated that the description herein may be adapted to other gas burning applications with multiple independently controlled burning zones and with gas burners having a different size, shape, configuration, material composition, etc. and still fall within the scope of the present invention. Thus, the detailed description herein is presented for the purpose of illustration only and not of limitation.

The present invention may also be described herein in terms of various functional components. It should be appreciated that such functional components may be realized by any number of hardware and/or software components, electrical, mechanical, gravitational, magnetic, and the like configured to perform the specified functions. In addition, the present invention may be practiced in any number of multi-zone burner contexts and that the multi-zone fireplace systems and methods described herein are merely exemplary applications of the invention.

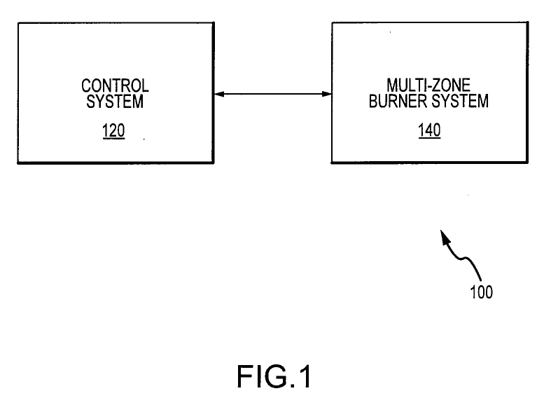

In accordance with various aspects of the invention, a multi-zone gas fireplace system and methods for control are disclosed. The multi-zone gas fireplace system is configured to provide a more realistic fire distribution and thus a more realistic fireplace experience to the user. In accordance with an exemplary embodiment, with reference to FIG. 1, a multi-zone gas fireplace system 100 comprises a control system 120 and a multi-zone burner system 140.

Control system 120 is configured to provide operational control to burner system 140 based upon input by a user, input by various sensors, and/or by various pre-programmed settings. Moreover, control system 120 is configured to monitor and provide functional feedback to a user. Control system 120 can comprise various processor, input/output devices and/or displays or other like devices. Control system 120 can selectively target various zones within multi-zone burner system 140 in order to automatically change the flame configuration within the multi-zone gas fireplace system.

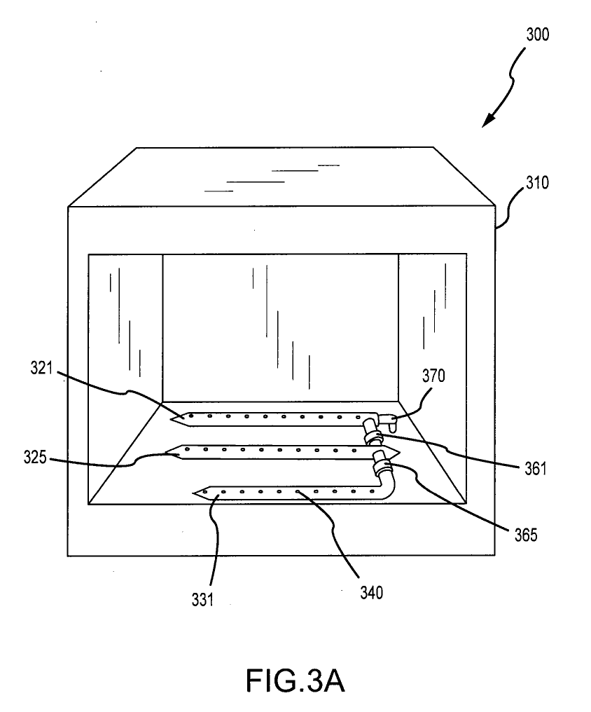

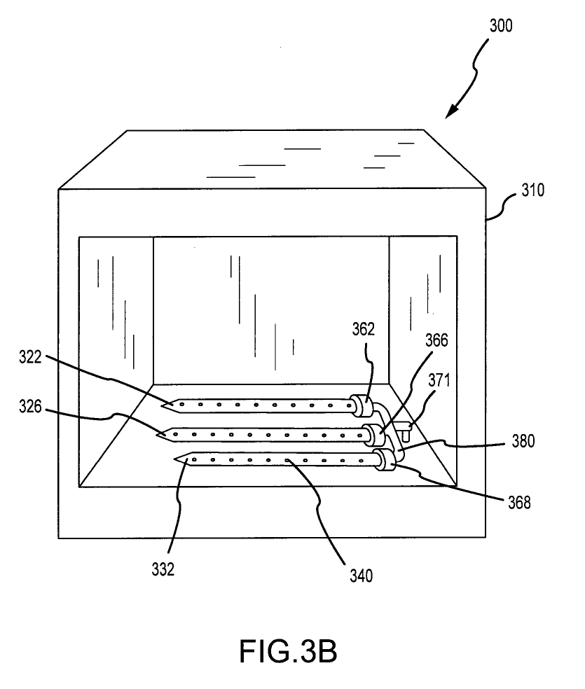

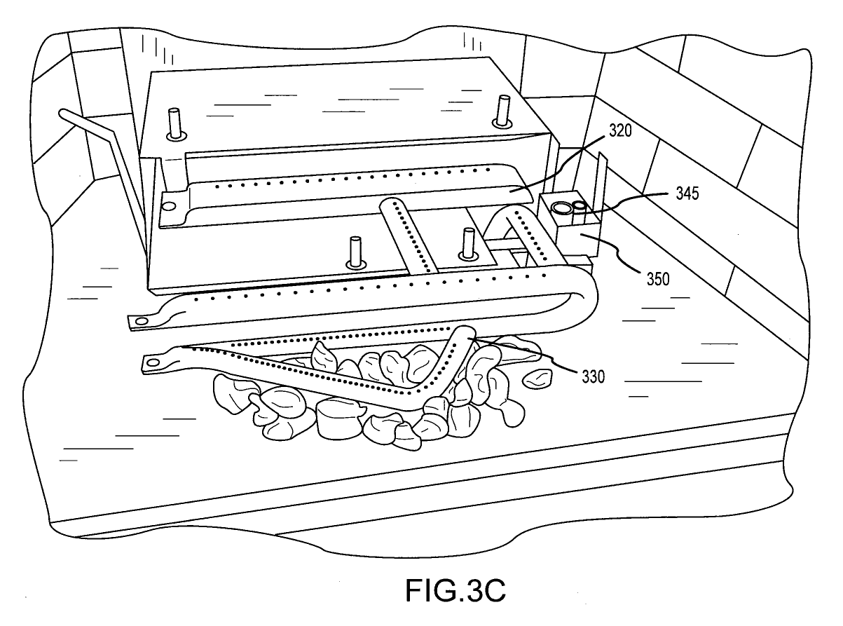

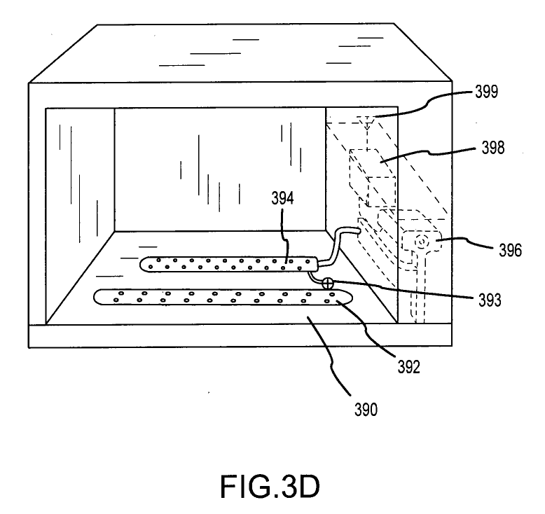

Multi-zone burner system 140 comprises a plurality of burners, e.g., at least two burners, configured within multiple zones that can provide a realistic fire experience. In exemplary embodiments discussed herein, multi-zone burner system 140 is configured for use in a gas burning fireplace. For example, in some embodiments, as in FIGS. 3A-3C, a multi-zone gas fireplace 300 comprises an in-the-wall fireplace 310. In other embodiments, the gas fireplace may be a stand-a-lone fireplace. However, burner system 140 may be employed in other flame systems, for example, systems that are configured for providing flame illumination and/or heating in which automatic and/or manual visualization and/or control of the flame from the burners is utilized or desirable.

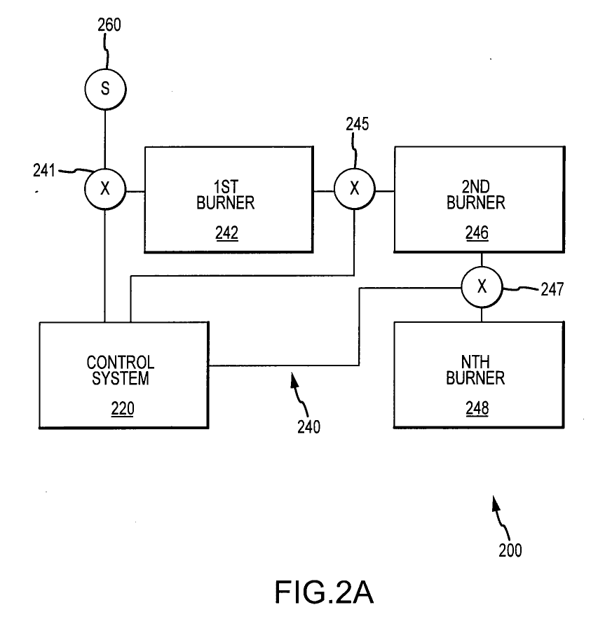

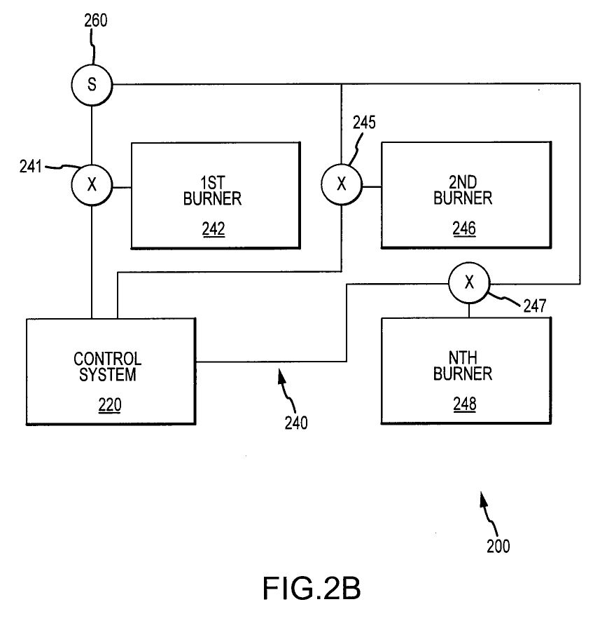

With reference to FIGS. 2A-3D, in accordance with various exemplary embodiments of the present invention, the multi-zone gas fireplace system comprises a firebox 310. The firebox may comprise a top, bottom, and sides. The firebox may be rectangular, trapezoidal, have rounded features, or any other aesthetically pleasing or functional shape. The firebox may be formed of discrete components that are fixed together or may be an integral formed structure. The firebox is configured to display the flames when the fireplace is in use, and may thus have any shape or configuration that is configured to display the fire. The firebox may further include a surround located within the firebox.

Also, the firebox may further comprise an opening. This opening is typically configured to facilitate viewing the fire and/or log set in the firebox. In addition to the firebox opening, the fireplace comprises a fireplace housing configured to at least partially surround the firebox, and the fireplace housing itself comprises an opening through which one may view the fire and/or log set in the firebox. In some embodiments, the size and location of the fireplace and firebox openings are coextensive. In yet other embodiments, the firebox opening is set back from the front face of the fireplace and may be a different size than the fireplace opening. Any of the various components, structures, devices, systems, and the like disclosed herein may reside within the firebox or without the firebox.

In accordance with further exemplary embodiments of the present invention, multi-zone burner system 140 comprises a plurality of burners and control valves configured to provide variable flames within one or more burner zone locations. In accordance with an exemplary embodiment, with reference to FIG. 2, a multi-zone burner system 240 comprises multiple burners, for example, a first burner 242 and a second burner 246, multiple control valves, for example, a first control valve 241 and a second control valve 245, and a gas supply 260. While an exemplary multi-zone burner system 240 can comprise only two burners and two control valves, any additional number of burners and control valves can be included to provide increased control over a functioning flame appearance. For example, third, fourth or nth burners 248 and control valves 247 can also be included. In the exemplary embodiment, first burner 242 and second burner 246 (and any nth burner 248) are configured within different zones or locations of the fireplace, spaced apart depending on any number of desired flame characteristics.

In the exemplary embodiment, burners 242, 246, and 248 are operatively coupled to gas supply 260 by control valves 241, 245, and 247. Control valves 241, 245, and 247 regulate the flow rate of gas into burners 242, 246, and 248 so as to regulate flame size, intensity, color, and/or other like characteristics. Control valves 241, 245, and 247 are configured to communicate with control system 220 so that a user can select a desired flame characteristic or pattern within control system 220, and control system 220 can suitably operate control valves 241, 245, and 247 at the desired flow rate. Control system 120 is operative to selectively communicate with control valves 241, 245, 247. For example, control system 120 can automatically increase the flow rate through control valves 241 and 247 and simultaneously automatically decrease the flow rate through control valve 245. In some embodiments, control valves 241, 245, 247 comprise solenoid valves, e.g., 9 volt solenoid valves. However, control valves 241, 245, and 247 can comprise any valve configuration that can control the supply and/or flow of gas from a gas supply to a gas burner, now known or hereafter devised.

Burners 242, 246, and 248 may be operatively coupled to gas supply 260 by control valves 241, 245, and 247 in a series arrangement, such as illustrated in FIG. 2A, in a parallel arrangement, such as illustrated in FIG. 2B, and/or a combination of series and parallel arrangements. For example, in accordance with an exemplary embodiment, with momentary reference to FIG. 3A, a plurality of burners 321, 325, 331 may be operatively coupled in series to gas supply 260 through a plurality of control valves 361 and 365. As such, gas can flow from gas supply 260 through valve 241 to burner 242, through valve 245 to burner 246, and through valve 247 to burner 248. In other embodiments, with momentary reference to FIG. 3B, a plurality of burners 322, 326, 332 may be operatively coupled in parallel to the gas supply through a plurality of control valves 362, 366, 368. For example, a gas supply manifold 380 or other distribution piping arrangement and/or gas distribution arrangement may be configured in between the gas supply and control valves 362, 366 and 368. In other embodiments of the invention, the gas supply may be suitably connected to the various burners directly and/or through other devices or systems presently known or developed in the future regarding the connection of a gas supply to a gas-consuming system.

Gas supply 260 is configured to provide the necessary fuel for operation of the multi-zone fireplace system. According to various embodiments, natural gas may be used as the gas in gas supply 260. In other embodiments, propane may be used as the gas in gas supply 260. In yet other embodiments, any other gas may be used that is suitable for use in gas fireplace systems. In some embodiments, as in FIG. 2A, a control value 241 is disposed between gas supply 260 and burner 242. In other embodiments, control valve 241 is eliminated or replaced by a supply valve 370 as in FIG. 3A. In further embodiments, with reference to FIG. 3B, supply valve 371 and control valves 362, 366, 368 are disposed between the gas supply and burners 322, 326, 332. Control valves 362, 366, 368 may be located at burners 322, 326, 332, at gas supply 260, at supply valve 370, and/or at any location between gas supply 260 and burners 322, 326, 332.

In accordance with an exemplary embodiment of the present invention, the multi-zone fireplace system comprises an ignition element to initiate combustion of the supplied gas from gas supply 360 to the various burners. In an exemplary embodiment, with reference to FIGS. 2A and 3C, the ignition element comprises a pilot flame element 350.

For example, once a user decides to operate the multi-zone fireplace system, a user engages the gas supply valve 370 into the “open” position. Control system 220 can then be used to selectively, variably, independently and/or automatically “open” control valves 241, 245, and/or 247. As a sufficient amount of gas emits from the burner ports, the gas ignites, due, at least in part, to the proximate position of pilot flame element 350 to burners 330, 320. In various embodiments, the pilot flame element is a continuously burning element, such that the fireplace system can be ignited upon demand. Thus, a very limited amount of gas, supplied from the gas supply, is directed to the pilot flame element such that it can operate continuously. In various embodiments of the invention, the ignition element ignites the gas flowing through one burner, or more than one burner, and any ignited burners in turn ignite the other burner elements. In other embodiments of the invention, the ignition element directly ignites all the burners.

In further embodiments of the invention, pilot flame element 350 is disposed between supply valve 370 and the burners, such that when the pilot flame element receives gas from the gas supply, the burners are also receiving gas from the gas supply. In other embodiments of the invention, the pilot flame element is separately coupled to the gas supply such that the pilot flame element receives gas from the gas supply even when the multi-zone burner system is turned off, such that the burners are producing no flame at the same time the pilot flame element remains lit.

In accordance with another exemplary embodiment, the ignition element, instead of comprising a pilot flame element 250, comprises an electronic spark element. Once a user decides to operate the multi-zone fireplace system, the electronic spark is engaged to provide the necessary ignition of the gas. While pilot flame elements and electronic ignitions are described herein as ignition sources for the supplied gas, any other ignition elements now known or hereafter developed may be utilized. For example the gas may be ignited by manual ignition such as by a match or by flint and steel.

In an exemplary embodiment, with reference to FIGS. 3A-3D, a multi-zone burner system comprises burners 320, 321, 322, 325, 326, 330, 331, and/or 332. For example, a burner can comprise a tube burner which comprises an elongated aluminum member having a plurality of burner ports 340 to allow a sufficient gas supply to emit from such ports such that a flame can be carried out in a realistic form. In an exemplary embodiment, a tube burner can comprise an inner diameter from about ¼″ to about 1½″ and the burner ports comprise openings from about 0.050″ to about 0.200″; however, other burner and port configurations, such as shapes, diameters, port opening sizes, cross-sectional areas, and the like, can be included. For example, in various embodiments, the burners may comprise arcs, u-shapes, triangles, twisted shapes and any other shape, for example, like the shapes illustrated in FIG. 3C. The burner ports may be spaced equally apart or tailored to a specific design, or random, such that the port configuration promotes a more realistic burning fire.

While the burners are described as comprising aluminum, such tube burners can comprise any suitable metal or alloy that can function as a burner member. Moreover, in accordance with other embodiments, the plurality of burners can comprise other configurations. For example, instead of comprising metal tube burners, the various burners may comprise a metallic or refractory “pan” burner, or any other burner configuration for use with burning gases, now known or hereafter devised. Regardless of the configuration, the plurality of burners may be covered by faux logs to simulate a real log stacking, in addition to hiding the burners, or in other exemplary embodiments, the burners may be encased inside of a faux log element, or left without any such log arrangements altogether.

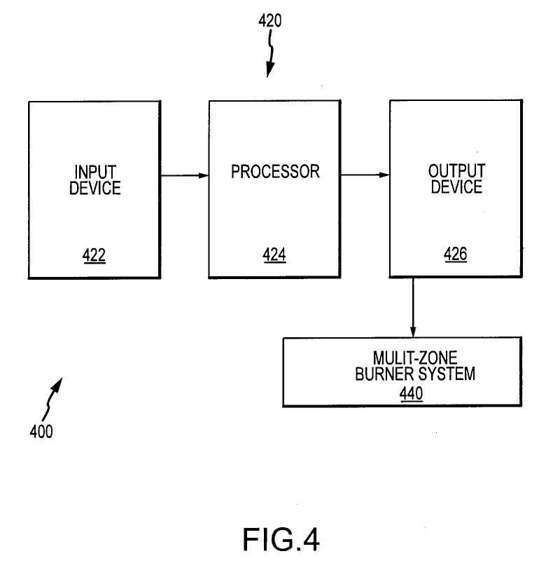

A user interacts with control system 120 to input the desired functional parameters and/or select the desired operational programs for the multi-zone burner system 140. In accordance with an exemplary embodiment of the present invention, with reference to FIG. 4, control system 420 comprises an input device 422, processor 424, and output device 426. In certain embodiments, various components within burner system 440 can provide a feedback signal to control system 420, such as to input device 422 and/or to output device 426, which provides feedback about the operation of multi-zone burner system 440 so a user can monitor the status.

Input device 422 is configured to provide input signals processor 424. In various embodiments, input device 422 can comprise, for example, keypads, touch screens, mouse elements, piezoelectrics, remote control signals, voice recognition elements, programs, and the like, that allow a user to communicate a command, transmit or otherwise provide input signals to control system processor 424.

In accordance with an exemplary embodiment, input device 422 comprises a user interface. Such an interface may comprise a keypad, a touch-pad, a touch screen, a voice command device, switches, rocker switches, push button switches, multi-position slide switches, trigger switches, rotary switches, toggle switches, snap action switches, levers and combinations thereof and other known means for accepting user input. For example, in a gas fireplace comprising three burning zones, the user interface may comprise three multi-position slide switches which allow the user to set three different gas flow rates associated with three different burning zones. In a further embodiment, the user interface may comprise a touch screen, Such that a user can select a burning zone by pointing to it on the touch screen and then choosing operating characteristics of the selected burning zone. In yet another embodiment, the user interface may comprise a keypad that allows the user to select the desired burning zone and then input the burning characteristics. In still another embodiment, the user interface may comprise a voice recognition system, such that the use can speak to the user interface and operate the fireplace system accordingly. Other known techniques and/or devices for accepting user input may be employed in various exemplary embodiments.

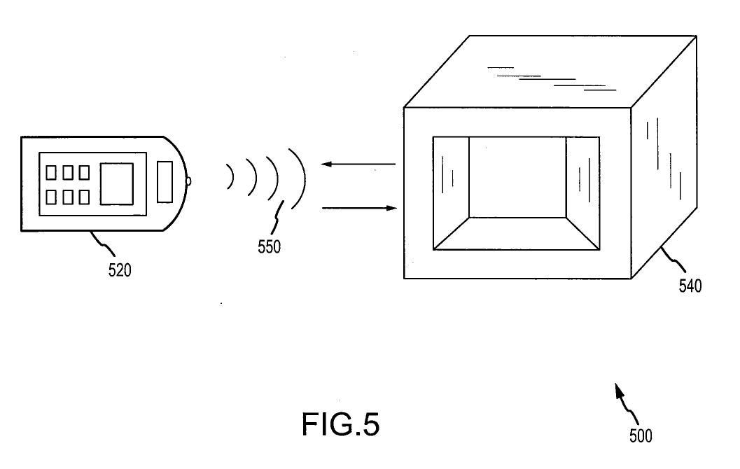

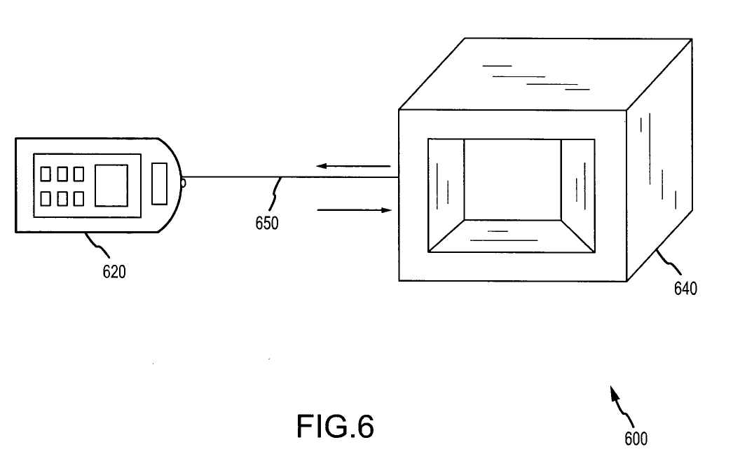

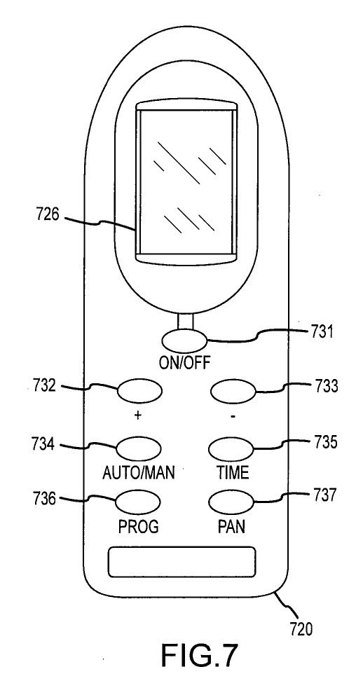

In accordance with an exemplary embodiment of the present invention, with reference to FIGS. 5-7, control system 420 comprises a user-employed remote control device to control the operation of a fireplace unit. For example, a user, using a remote control device 520, can input various commands that the user wishes to transmit to the fireplace control system, various operational parameters or characteristics, for example, flame strength, fan strength, temperature, flame distribution, and the like.

Processor 424 may comprise any micro-processor or other computer devices configured to interpret and/or process the input signals, and then convey operational signals to output device 426. For example, if a user inputs a command to increase gas flow by opening one of the control valves of the multi-zone fireplace system, processor 424 manipulates the information into the proper format and directs it towards the proper functional element via output device 426. Processor 424 may further comprise other functions besides directing signals to and from the user to the fireplace system. Processor 324 may provide the date, process feedback signals, monitor various fireplace operations, interact with external sensors, and the like. In some embodiments, the multi-zone gas fireplace system comprises one processor. In other embodiments, the multi-zone gas fireplace system comprises a plurality of processors.

Output device 426 communicates with the multi-zone burner system 440, and directs the various components of burner system 440 to actuate or operate in a desired manner. In accordance with various exemplary embodiments, output element 426 can transmit the processed information from processor 424 to multi-zone burner system 440. According to one embodiment of the invention, output element 426 communicates with multi-zone burner system 440 via the Internet, an Ethernet, a local area network, telephone lines, wireless telephone networks, satellite networks, radio waves and/or any other network and/or communication system now existing or hereafter devised. For example, in certain embodiments, output device 426 comprises a wireless transmission device, such as a remote control 520 illustrated in FIG. 5, communicatively coupled to a receiver/transceiver proximate multi-zone burner system 540. In other embodiments, output device 426 comprises a wired connection 650 directly coupled to controls proximate multi-zone burner system 640.

According to an exemplary embodiment, in which control system 420 comprises a remote control, such as that illustrated in FIGS. 5-7, remote control 520 comprises a receiver, transmitter, and/or transceiver in order to send signals to and receive signals from multi-zone burner system. In some embodiments, a remote control signal 550 comprises a signal within a range from about 200 MHz to about 500 MHz. However, remote control signal 550 may comprise various other signal transmission/receiving modes and/or frequencies. For example, remote control signal 550 may comprise any signal that allows a user to wirelessly communicate between fireplace 540 and remote control device 520. In various embodiments remote control signal 550 comprises the following signals and/or any combination thereof: infrared, ultrasonic, digital, analog, radio, satellite, cellular telephone and like signals now known or developed in the future for wirelessly transmitting information. In other embodiments, remote control 520 allows a user to turn the fireplace on and off, adjust the burners independently of the other burners, read the time, set a program for the fireplace, set a desired temperature for the fireplace, set the fireplace to automatic or manual operation, set a fan strength, and the like.

According to an exemplary embodiment, output signal 550, 650 communicates with the multi-zone burner system in order to create the flame characteristics and the environment which a user desires. For example, a user may open gas supply valve 370 in order to supply gas to the burner system. In another embodiment, a user may direct the burner system to ignite pilot flame 350 and/or other ignition elements. In other embodiments, a user may set the flow rate of control valve 361, 365 in order to produce a flame of one intensity in burner 325 and a flame of a different intensity in burner 331. According to another embodiment, control valves 362, 366, 368 can be independently adjusted to provide a desired burn pattern. As such, a user controls the gas to the various burners, thereby customizing the flame combustion and, subsequently, the fireplace experience. In still other embodiments, a user may change a fan and/or blower setting within the fireplace in order to distribute heat from the fireplace throughout the operating area of the fireplace.

In accordance with various embodiments of the present invention, the multi-zone burner system comprises a transmitter, receiver, and/or transceiver to send and receive wireless control signals. In other embodiments control system 420 communicates over a wired connection with the fireplace. With reference to FIG. 3D, the fireplace further comprises a transmitter, receiver, and/or transceiver 399 and a processor 398 to interpret control signals and convey such control signals to the various fireplace functional elements. The fireplace processor 398 likewise receives feedback input from the various fireplace functional elements, converts it into feedback signals for transmission to control system 420 and conveys the feedback signals via various means discussed above in relation to communication between control system 420 and multi-zone burner system 440. In this embodiment, processor 398 may be located proximate the firebox. In other embodiments, processor 398 may be located proximate remote control 520 and/or proximate other elements of control system 420. In still other embodiments, the multi-zone gas fireplace system may comprise a plurality of processors. For example one processor may be located proximate the firebox and another processor may be located proximate remote control 520, and/or proximate a touch panel, keypad, switch or any other element of the multi-zone gas fireplace system.

In accordance with various exemplary embodiments of the present invention, the multi-zone fireplace and control system comprises monitoring elements such that a user has operational information from which to make decisions regarding the function of the fireplace system. For example, various monitoring elements may be suitably connected to the various operating elements of the system, such as gas flow meters to monitor how much gas is being supplied to the various burner elements. Temperature monitors, thermocouples, thermopiles, thermistors, thermostats, timers, and the like are similarly provided by the present invention in order to provide a user with operating information about the system.

In accordance with an exemplary embodiment of the present invention, other monitoring elements suitably connected to various sensors may further contribute to the realistic fireplace experience. For example, a motion sensor, infrared sensor, and the like may be used to determine the occupancy of an environment. As the occupancy of the environment diminishes, likewise does the fire within the fireplace. In other words, as a sensor determines that the occupancy of an environment decreases, the fireplace control system directs the various gas supply and valves to slowly close or shut down, thereby again creating the effect of a dying down fire. Also, a sensor determining that the, occupancy of a room is increasing, may direct the fireplace to slowly ramp up the fire. Other sensors may likewise be suitably configured to alter the operation of the fireplace system, for example, daylight sensors, temperature sensors, and the like.

In various exemplary embodiments, as the sensors and monitoring elements herein described receive information about the operating conditions of the multi-zone fireplace system, the sensors and monitoring elements communicate such information to control system 120. Control system 120 receives and interprets the information, analyzes the information in connection with user-defined parameters and/or control system defined parameters, and communicates with control valves 241, 245, and 247. For example, in some embodiments, control system 120 communicates with the control valves via fireplace transceiver 399. In other embodiments, the control system communicates directly with the control valves. Control system 120 instructs control valves 241, 245, and 247 to open, close and or adjust the flow rate through the control valves in order to comply with user-defined and/or control system-defined parameters. Processor 424, such as fireplace processor 398, may participate in such instruction. This instruction may occur through any of the communication methods disclosed herein, or through any other presently-known or later-developed methods for communicating with a system component such as a control valve.

In an exemplary embodiment of the present invention, control system 420 comprises a program that pre-determines the operation of burner system 440. For example, as briefly described above, to create a more realistic and/or satisfying fireplace experience, a user may wish to direct the fireplace to function as a real fireplace might. Fires in wood-burning fireplaces die down after time, and unless rekindled, will eventually extinguish themselves. To recreate such an experience, a user, via a pre-programmed input, can direct the present invention to simulate the same result. For example, control system 420 can direct the various valves and burners to slowly close and shut down, thus recreating the dying fire experience. This exemplary embodiment is merely one realistic controlled use, and it should be appreciated that other exemplary programmed embodiments are provided by the present invention.

With reference to FIG. 2A, an exemplary embodiment of a multi-zone gas fireplace system program is now described. For example, a user may instruct control system 220 to simulate a rapidly-growing fire to a certain intensity and/or for a certain time. After the fire has reached the specified intensity and/or the specified time has elapsed, the user may further instruct the control system to simulate a slowly-dying fire. Control system 220 then instructs control valve 241 to open and increase flow rate in response to the user instructions. Once control valve 241 has reached a calculated flow rate depending on the user input, control system 220 then instructs control valve 245 to open. Once control valve 245 has reached a calculated flow rate, control system 220 then instructs control valve 247 to open. At the appropriate time, control system 220 then instructs, in turn, control valve 247 to begin closing, control valve 245 to begin closing, and control valve 241 to begin closing. The decreasing flow rate is calculated to allow the flames in the fireplace system to be extinguished according to the parameters defined by the user. The opening and closing of the control valves is done automatically, in accordance with the parameters defined by the user.

With reference to FIG. 2B another exemplary embodiment of a multi-zone gas fireplace system program is disclosed. For example, a user may instruct control system 220 to randomly move the flames between burners 242, 246 and 247 in order to produce a visually stimulating user experience. A user may also specify which burners should produce flame according to a specified schedule. According to the parameters specified by the user, control system 220 communicates with control valves 241, 245, 247 in order to instruct the control valves to adjust their flow rates in accordance with the user's instructions. Once the control system receives the user's instructions, control valves 241, 245 and 247 operate automatically without further instruction from the user.

In one embodiment, still with reference to FIG. 2B, after the user has specified a program, the control system will instruct control valve 241 to operate at a specific flow rate, such that flame is emitted from burner 242 but not from burners 246 and 248. Then the control system will instruct control valve 245 to open and the control system will instruct control valve 241 to close, such that flame is only emitted from burner 246. Next, the control system will instruct control valve 247 to operate at a specific flow rate and it will instruct control valve 245 to close, such that flame is only emitted from burner 248. In a similar manner, the program will continue to display flames at the various burners and at varying intensities according to the program the user chose, whether it be a randomized flame display, a specific flame display pattern, or any other program specified by the user. For example, burners 242 and 246 may emit flame while burner 248 does not; burners 246 and 248 may emit flame while burner 242 does not; burners 242 and 248 may emit flame while burner 246 does not; burners 242, 246 and 248 may operate simultaneously at varying intensities; and burners 242, 246, and 247 may variously and/or independently be opened or closed according to the user-defined program.

According to other embodiments, a user may specify a desired temperature for the room, and the processor can determine from certain operating parameters of the multi-zone burner system how to increase/decrease gas flow in order to achieve the desired temperature. For example, a temperature sensor located in the multi-zone gas fireplace system communicates with control system 420. Control system 420 interprets the signal, calculates a burn rate to achieve the user-specified temperature, and communicates with the control valves in order to achieve the desired temperature. The control valves operate automatically without further input from the user after a temperature has been specified. Control system 420 continues to receive information from the fireplace and changes the burn rate accordingly to maintain the desired temperature.

Thus, a new and improved multi-zone gas fireplace system and method for control has been described above with reference to various exemplary embodiments. However, those skilled in the art will recognize that changes and modifications may be made to the exemplary embodiments without departing from the scope of the present invention. For example, the various components may be configured in alternate ways depending upon the particular application or in consideration of cost. These and other changes or modifications are intended to be included within the scope of the present invention, as set forth in the following claims.

We claim:

1. A multi-zone gas fireplace system for providing a variable flame display, comprising:
a firebox;
a multi-zone burner system configured within said firebox, comprising:
a plurality of burners located in a plurality of zones;
a plurality of valves coupled to said plurality of burners;
a gas supply which provides a gas to said plurality of burners, wherein a plurality of flow rates of said gas is controlled by said plurality of valves; and
at least one ignition source configured to ignite said gas; and
a control system in communication with said multi-zone burner system, comprising:
an input element, responsive to a user input;
a processor in communication with said input element; and
an output element in communication with said processor, wherein said control system communicates with said plurality of valves to adjust said plurality of flow rates in order to provide the variable flame display.

2. A multi-zone gas fireplace system according to claim 1, wherein said plurality of burners comprises at least three burners.

3. A multi-zone gas fireplace system according to claim 1, wherein said plurality of burners comprises tube burners.

4. A multi-zone gas fireplace system according to claim 3, wherein said plurality of burners comprises aluminized burners.

5. A multi-zone gas fireplace system according to claim 3, wherein said plurality of burners comprises an inside diameter from approximately 0.25 inches to 1.5 inches.

6. A multi-zone gas fireplace system according to claim 1, wherein said plurality of burners further comprises a plurality of burner ports located within said plurality of burners, wherein said burner ports are configured to allow said combustible gas to escape said plurality of burners in order to produce a flame.

7. A multi-zone gas fireplace system according to claim 6, wherein said plurality of burner ports comprises openings between 0.050 inches and 0.200 inches.

8. A multi-zone gas fireplace system according to claim 1, wherein at least one of said plurality of burners comprises an aluminized tubing having at least a 0.75 inch diameter.

9. A multi-zone gas fireplace system according to claim 1, wherein said plurality of valves comprises at least one of a gas supply valve and a control valve.

10. A multi-zone gas fireplace system according to claim 1, wherein said plurality of valves are connected to said plurality of burners in series.

11. A multi-zone gas fireplace system according to claim 1, wherein said plurality of valves are connected to said plurality of burners in parallel.

12. A multi-zone gas fireplace system according to claim 1, wherein said plurality of valves comprises a first valve group connected in series, and a second valve group connected in parallel with said first valve group.

13. A multi-zone gas fireplace system according to claim 12, wherein said second valve group comprises at least two valves, wherein said at least two valves are connected in parallel.

14. A multi-zone gas fireplace system according to claim 12, wherein said second valve group comprises at least two valves, wherein said at least two valves are connected in series.

15. A multi-zone gas fireplace system according to claim 1, wherein said plurality of valves does not comprise a gas supply valve.

16. A multi-zone gas fireplace system according to claim 1, wherein said ignition source comprises at least one of a pilot flame and an electric ignition system.

17. A multi-zone gas fireplace system according to claim 1, further comprising a fireplace sensor disposed within the multi-zone gas fireplace burner system, wherein said fireplace sensor monitors an environmental condition.

18. A multi-zone gas fireplace system according to claim 17, wherein said fireplace sensor comprises a temperature sensor.

19. A multi-zone gas fireplace system according to claim 18, wherein said fireplace sensor comprises at least one of a thermocouple, a thermistor, and a thermopile.

20. A multi-zone gas fireplace system according to claim 17, wherein said fireplace sensor comprises a motion detector.

21. A multi-zone gas fireplace system according to claim 1, wherein said control system further comprises a preset program, wherein said preset program is operative to cause said plurality of valves to automatically open and close in order to follow a simulated, natural fireplace condition.

22. A multi-zone gas fireplace system according to claim 1, wherein said control system comprises a remote control which communicates wireless using a radio signal between 200 MHz and 500 MHz.

23. A multi-zone gas fireplace system according to claim 1, wherein said user input comprises a temperature setting, and wherein said control system determines a plurality of settings for said plurality of valves in response to said user input, in order to produce said temperature setting.

24. A multi-zone gas fireplace system for control by a user, comprising:
a first zone having at least one burner and a second zone having at least one burner, wherein said at least one burner in said first zone and said at least one burner in said second zone each comprise a plurality of orifices;
a first valve coupled to said first zone, and a second valve coupled to said second zone;
a gas supply which provides a gas to said first zone and said second zone, wherein said gas supply is coupled to said first valve and said second valve;
a control system, comprising an input element, a control processor, and an output element, wherein said input element receives a user input from the user, wherein said control processor produces a manipulated input from said user input, wherein said output element communicates said manipulated input to said first valve and said second valve in order to produce a fireplace condition in accordance with said user input; and
wherein said first valve regulates a first gas flow rate, wherein said second valve regulates a second gas flow rate, and wherein said first gas flow rate may be different than said second gas flow rate.

25. A multi-zone gas fireplace system according to claim 24, wherein said control processor is located proximate the firebox.

26. A multi-zone gas fireplace system according to claim 24 further comprising a fireplace sensor disposed within the multi-zone gas fireplace system, wherein said fireplace sensor measures a fireplace condition.

27. A method of operating a multi-zone gas fireplace system to produce a realistic wood-burning fireplace condition, comprising the steps of:
providing a first burner in a first zone, a second burner in a second zone, and a gas;
providing at least one control valve disposed between said first burner and said second burner; and
communicating an instruction from a control system to said at least one control valve to automatically control operation of said at least one control valve and to facilitate the realistic wood-burning fireplace condition.

28. A method according to claim 25, wherein the method further comprises the steps of:
automatically controlling said at least one control valve to provide said gas to at least one of said first burner and said second burner at a first flow rate, wherein said first flow rate is increasing, thereby producing a first flame that simulates growth of a fire;
automatically controlling another control valve to allow said gas to flow at a second flow rate within said second burner, wherein said second flow rate is increasing, thereby producing a second flame that facilitates an appearance of an increasing fire according to the realistic wood-burning fireplace condition.

29. A method according to claim 26, wherein after a predetermined time, the method further comprises the step of automatically decreasing a first intensity of said first flame and automatically decreasing a second intensity of said second flame, wherein said first and second intensities are slowly decreased by at least one of the steps of:
shutting off at least one of said first burner and said second burner, or
decreasing said first and second flow rates thereby facilitating an appearance of a dying fire according to the realistic wood-burning fireplace condition.
